(19) United States
(12) Patent Application Publication
(10) Pub. No.: US 2007/0112675 A1
(43) Pub. Date: May 17, 2007

(54) Goods and Services Locator Language for Uniform Resource Identifier Components

(76) Inventor: Brenda Jo Flinn, Athens, OH (US)

Correspondence Address: BRENDA J. FLINN, 340 WEST STATE STREET, UNIT # 3, ATHENS, OH, 45701, US

(21) Appl. No.: 11/164,178

(22) Filed: Nov. 14, 2005

(51) Int. Cl. G06Q 99/00

(52) U.S. Cl. 705/50

(57) ABSTRACT

A process and method to define, describe, order, and display the components that comprise the query portion of a Uniform Resource Identifier (URI) into a human readable, easy to remember string of characters that map the physical location of a resource.

A portion of the disclosure of this patent document contains material subject to copyright protection. Copyright owner, Brenda J. Flinn, has no objection to the facsimile reproduction by anyone of this patent document and the disclosure contained herein as it appears in the United States Patent and Trademark Office patent file or records. All other uses remain subject to copyright with all rights reserved to herein stated person.

Before explaining the patent embodiment(s), it should be understood that the process and methods of this invention are not limited in application or use to the details of construction and arrangement of parts illustrated in this patent disclosure by description and accompanying drawing(s). The illustrative embodiment(s) herein may be implemented or incorporated in other embodiments, variations, and modifications, and may be practiced or carried out in various ways. Furthermore, the items and expressions employed herein have been chosen for the purpose of describing the illustrative embodiment(s) of the present invention for the convenience of the reader and are not for the purpose of limitation.

### BACKGROUND OF THE INVENTION

1. Field of the Invention

The present invention relates to the field of software applications that employ Standard Generalized Markup Language (SGML), regular expressions, and object-oriented programming languages to process a Uniform Resource Identifier (URI).

2. Background Art

Prior to the advent of the World Wide Web, computers and computer networks shared information in machine-readable language. For example,
+1300042777
+1400593412
+1200274029
was a machine language program which added a margin above cost and stored the result in sales price.

Generalized Markup Language, which eventually grew into the more robust form known as SGML, now International Standard ISO 8879: 1986, attempted to make the information human-readable as well as machine-readable. For example,

<margin>25.00</margin>
<cost>100.00</cost>
<sale-price>125.00</sale-price>

was typical of a program that could be read by a computer program and a human person.

SGML offered many advantages including (1) a way to define a document markup language, (2) a way to define character sets used in a document, (3) a way to define document structure, and (4) a way to define elements. SGML separated document structure from document format with the resulting data easily converted to other formats including analog voice data, digital data, and file outputs. The SGML standard specified the format of a Document Type Definition (DTD) that, in turn, specified a specific markup language structure and elements.

Today, the use of SGML is widespread. It is implemented by government, military, aircraft, automotive, and insurance industries, just to name a few. The CALS Table Model is one of the most utilized features of SGML in which to store structured information within a table, including but not limited to text, images, metadata, audio, video, and other objects.

While SGML is heavily used in the context of the document structure, it has never been applied by a process or method to the most challenging character string to read, the URI. An example of a URI presented in a World Wide Web browser address field is:
http://stores.lowes.com/lowes/cqi/site?site=1866&address=&desiqn=default& lanq=en&mapid=US&snum=159&sname=LOWE'S&sw=true&zipid=45701&bm ap=&zip=45701

The above URI fails to give the user easily readable information about the resource. The user is unable to act on the information save for selecting the hyperlink and following where it goes. This creates difficulty distinguishing the identity of the original resource from the identity of the web page describing it. A user would have trouble remembering the above URI because it lacks meaningful components in an easy to remember format.

Prior art does nothing to rectify this situation and makes no attempt to address the issue of the human unreadable URI we all experience in our browser address bars, as our hyperlinks, and even our scrawls on paper with ink. As it is, we cannot easily write it, speak it, or remember it.

The proposed invention closes a deficiency in U.S. Pat. No. 6,342,907 issued to Petty, et al. on Jan. 29, 2002 in which the Panel Definition Markup Language allowed a user to specifically define the components of a form down to placement of the last pixel, but failed to provide a means of defining content contained in the form input areas as name-value pairs and associating said name-value pairs into a human-readable URI displayed in a web browser address bar, which ultimately is a vital and necessary part of the overall user interface experience.

The proposed invention also closes a deficiency in the most recently issued patent to use XML, a subset of SGML, to create a user interface. There is no claim regarding how a URI or its URL subset should appear in the address bar of a web browser in U.S. Pat. No. 6,920,607 granted to Ali, et al. on Jul. 19, 2005.

Finally, the proposed invention overcomes the limitations in published patent disclosure 20040199870 where Anderson programmatically assigns an identifier to each header cell in a CALS table converted into an HTML table specifically by embedding the identifier in the identifier attribute for each header cell. Anderson does not address using the ID attribute to uniquely identify non-header cells containing URI content displayed within each non-header cell.

Thus, there are significant gaps left by prior art as to how a URI should be displayed, particularly how the characters in the query portion of the URI are displayed.

### SUMMARY OF THE PRESENT INVENTION

The present invention is a process and method to define, describe, order, and display the components that comprise the query portion of a Uniform Resource Identifier (URI) into a human readable, easy to remember string of characters that map the physical location of a resource.

The disclosure(s) contained within this patent application allows the proposed invention to specify the sequence character data is displayed in the address bar of a web browser, thus ensuring the query component of the URI to be easily human-readable and instantly actionable without further drill down for information.

1. Definitions

For the purposes of the patent disclosure(s) contained herein, a resource is defined as anything that has an identity. The resource may be or may not be network retrievable.

A Uniform Resource Identifier (URI) is a string of characters that identifies a resource, whether a resource is tangible or intangible. A URI does not represent the good(s) and/or service(s) in any way, nor offer a representation of a good(s) and/or service(s). A URI can be classified further as a name, locator, or both for a good(s) and/or service(s). Hence a URI can be used to identify a conceptual entity mapping of a resource to the physical location of that resource, being a good(s) and/or service(s), in a given space and time period. A URL, being a subset of a URI, can be used with an electronic device like, but not limited to, a computer, mobile phone, smart phone, personal digital assistant, interactive television system, voice response system, peer-to-peer network, kiosk, network appliance, RFID tag, as well as a writing device. A URI can be transcribed in non-electronic form with ink and paper.

A URI can be further classified as a Uniform Resource Locator (URL), a subset of URI, that identifies a resource via a representation of its primary access mechanism, like a network “location,” rather than identifying the resource by name or by some other attribute(s) of that resource. For the purposes of this patent disclosure, the terms URI and URL are interchangeable.

Use of the slash (“/”) character in a URI for separating hierarchical components does not imply that the resource is a file or that the URI maps to an actual file system pathname.

Scripting language means any programming language, whether interpreted or compiled, capable of handling hash table data structures.

A namespace may reference a schema definition or document type definition, at a Uniform Resource Name (URN), being a globally unique and persistent subset of Uniform Resource Identifier (URI), which may not exist in electronic format when it is not needed for validation. In referencing such, the namespace is thus derived from a scripting language package or module. A namespace stores information about an identifier and the value to which it is bound.

A timestamp can be represented in various ways and is not limited to RFC 822, RFC 850, ANSI C, Unix Cron, or any particular time zone.

Internationalization can be represented according to ISO 10646 Universal Multiple-Octet Coded Character Set or Unicode. A language attribute identifies natural language used by the content of the associated element as defined by RFC 1766, like en, en-US, and en-UK. Element DIR, when used with a table as defined by Table Model RFC 1942 incorporated herein, indicates the direction characters are written.

A client is a program that establishes connections for the purpose of sending requests. A server is an application program that accepts connections in order to service requests by sending back responses. A proxy is an intermediate program which acts as both a client and a server for the purpose of making requests on behalf of other clients. Requests are serviced internally or by passing them on, with possible translation, to other servers. A transparent proxy is a proxy that does not modify the request or response beyond what is required for proxy authentication and identification.

The World Wide Web is a network of information resources, and it relies on three mechanisms to make resources available, including (1) a uniform naming scheme for locating resources on the World Wide Web, (2) communication protocols, especially the Hyper Text Transfer Protocol (HTTP), and (3) hyper text like HTML, XML, and XHTML.

The Hyper Text Markup Language (HTML) is an SGML application. The Extensible Markup Language (XML) is a proper subset of SGML. Therefore, programming code that processes SGML can also process XML and HTML applications.

An HTML form provides a commonly used mechanism to collect and disseminate information. It contains any number of form elements and controls as defined in the HTML 4.01 specification maintained by the W3C. A sample form may contain programming code similar to the following:

<form method=”post” action=”/cgi-bin/formdata”>
<p><label>Comments:
<input name=”comments” type=”text” size=”25” value=” “>
</label></p>
</form>

The above form example would be exemplary of a basic text form in both HTML and XHTML. It would also be exemplary of a form card in Wireless Markup Language and/or VoiceXML under the Wireless Application Protocol. The form function remains the same for XForms also, an XML representation of a form.

All markup languages provide support in forms for (1) ID, a unique name, (2) NAME, string of 1-8 characters starting with a-z or A-Z, followed by a-z or A-Z, hyphen, or period, and (3) NAMES, multiple NAME values with each string separated by one or more spaces, tabs, or returns.

The POST method is used with an HTML form to submit information that alters data stored on a web server. The POST request always includes a body containing the submitted information formatted like a query string. The POST method is used in (1) annotating an existing resource, (2) posting a message to a bulletin board, newsgroup, news feed, or similar group of articles including man-pages, (3) providing a block of data, like in the result of submitting a form, to a data handling process and/or script(s), and (4) extending a database through an append operation. The POST method is used to request that the server accept the entity enclosed as a new subordinate of the resource.

An entity is the data transferred in the payload of a request or response. An entity consists of meta-information in the form of entity header fields and content in the form of an entity body.

A query string passes additional information thru name-value pairs. For example,

<input type=“hidden” name=“state” value=“Texas”>

where the name-value pair is represented by the strings “state”=“Texas”.

Name-value pairs are processed by scripts using the hash table data structure. A hash, sometimes known as an associative array, is an unordered collection of key-value pairs which corresponds to name-value pairs. Elements in a hash are accessed using a string known as a key, which must be unique.

A database is a collection of related files. A database and software that controls the database is called a database management system. A database is comprised of at least one table, which consists of a row and column. Each row, also referred to as a record, contains data about one single entity. Each column is also referred to as a field. A field may receive the name or key from a hash, as in the previous example, “state”. The value of the same hash is placed in the row below the corresponding field, as in the previous example, “Texas”.

2. SGML Application

The following recitation sets forth the language governing the invention thus defining an SGML vocabulary specifying the syntax and components of the query portion of a URI.

############################################################

<! - - © by Brenda J. Flinn, October 1, 2005. All rights
reserved. - - >

<! - - Uniform Resource Name (URN) − −>
<! DOC TYPE gsll PUBLIC “+//ATHENSLEGALNEWS - Goods and
Services Locator
Language GSLL//DTD gsll >
<! - - The Goods and Service Locator Language (GSLL) consists of
the following elements and attributes, but is not restricted to only
these elements and attributes in order to adequately describe a good
and/or service - - >

<! ELEMENT language ∘ ∘ ANY #REQUIRED>
<! ELEMENT code ∘ ∘ ANY #REQUIRED>
<! ELEMENT condt ∘ ∘ (G/Y/R) #REQUIRED>
<! ELEMENT name ∘ ∘ ANY #REQUIRED>
<! ELEMENT telefone ∘ ∘ ANY #REQUIRED>
<! ELEMENT city ∘ ∘ ANY #REQUIRED>
<! ELEMENT state ∘ ∘ ANY #REQUIRED>
<! ELEMENT country ∘ ∘ ANY #REQUIRED>
<! ELEMENT gsdesc ∘ ∘ ANY #REQUIRED>
<! ELEMENT staddres ∘ ∘ ANY #REQUIRED>
<! ELEMENT gpscord ∘ ∘ ANY*>
<! ELEMENT zipcode ∘ ∘ ANY #REQUIRED>
<! ELEMENT gsqty ∘ ∘ ANY #REQUIRED>
<! ELEMENT howsell ∘ ∘ (negotiated sale | sealed bid | auction |
barter)

#REQUIRED>

<! ELEMENT contact ∘ ∘ ANY #REQUIRED>
<! ELEMENT email ∘ ∘ ANY>
<! ELEMENT trial ∘ ∘ (yes | no)?>
<! ELEMENT othstadd ∘ ∘ ANY>
<! ELEMENT othcity ∘ ∘ ANY>
<! ELEMENT othstate ∘ ∘ ANY>
<! ELEMENT othzipcd ∘ ∘ ANY>
<! ELEMENT othcntry ∘ ∘ ANY>
<! ELEMENT cmpynme ∘ ∘ ANY>
<! ELEMENT timestmp ∘ ∘ ANY #REQUIRED>
<! ELEMENT otherurl ∘ ∘ ANY>

<! ELEMENT pinglist ∘ ∘ (y | n)?>

<! ELEMENT media ∘ ∘ (image | Quicktime movie | Flash |
podcast |

powerpoint)*>

<! ELEMENT busdesc ∘ ∘ ANY>
<! ELEMENT bushours ∘ ∘ ANY #REQUIRED>
<! ELEMENT credtcrd ∘ ∘ (y | n)>
<! ELEMENT article ∘ ∘ (#PCDATA)>
<! ATTLIST article ∘ ∘ (title, author, (publication date,
publishing company)?

[CDATA])

<! ELEMENT alttag ∘ ∘ ANY>
<! ELEMENT help ∘ ∘ ANY>
<! ELEMENT bundle ∘ ∘ ((y | n), ANY+)>

NOTE 1->When using ELEMENT code, the value represented by it may be derived from such industry standards as the Standard Industrial Classification (SIC), North American Industry Classification System (NAICS), or other suitable classification system as declared in the namespace.
NOTE 2->When using ELEMENT condition, G=green for full warranty, Y=yellow for limited warranty, and R=red for “as is, where is.”
   Element definitions:
language->declares text language of data.
code->good and/or service registry, see NOTE 1 above.
condt (G/Y/R)->condition of a good and/or service, see NOTE 2 above.
name->good and/or service title.
telefone->telephone number to call for direct information on good and/or service.
city->physical location of good and/or service being a city.
state->physical location of good and/or service being a state.
country->physical location of good and/or service being a country.
gsdesc->description of good and/or service.
staddres->physical location of good and/or service being a street address.
gpscord->physical location of good and/or service being global positioning coordinates.
zipcode->physical location of good and/or service being a zip code.
gsqty->quantity of a good and/or service available for sale.
howsell (negotiated sale|sealed bid|auction|barter)->method of sale.
contact->name of person responsible for selling good and/or service.
email->email of contact person and/or business.
trial (yes|no)->indicates a trial version of a good and/or service available.
othstadd->street address of contact person or business if different from physical location of good and/or service.
othcity->city of contact person or business if different from physical location of good and/or service.
othstate->state of contact person or business if different from physical location of good and/or service.
othzipcd->zip code of contact person or business if different from physical location of good and/or service.
othcntry->country of contact person or business if different from physical location of good and/or service.
cmpnynme->company name.
timestmp->timestamp.
otherurl->URL of company website or differing specification information.
pinglist (y|n)->ping list provided or not provided by seller for RSS/XML feed.
media (image|Quicktime movie|Flash|podcast|powerpoint)->indicates type of media.
busdesc->description of business providing the good and/or service for sale.
bushours (day, hours)->hours business is open, including days of week.
credtcrd (y|n)->accepts credit cards, either y for yes or n for no.
article->any content, but must have a title, author, and optional publication date and name of publishing company as attributes.
alttag->tool tip.
help->context-sensitive help and/or link to help files.
bundle (y|n)->attach URI to table cell.

One skilled in the art will appreciate that many variations are possible within the scope of this invention. Thus, while the invention has been particularly shown and described with the embodiments thereof, it will be understood by those skilled in the art that these and other changes in form and details may be made therein without departing from the scope and spirit of the invention. While the best mode of the invention disclosed in the preferred embodiments herein show specific elements with specific arguments and attributes, many variations in elements, arguments, and attributes are within the scope of the invention.

### PREFERRED EMBODIMENT

This invention disclosed herein provides a process and method to display a human-readable, meaningful URI that is consistent in ordering query components describing a good and/or service and is immediately actionable by a user.

The SGML application herein disclosed in this invention defines and displays the character string schema of a URI. URI syntax is most commonly set forth as follows:

<scheme>://<authority><path>?<query>

Using this invention, the URI is displayed into the following human-readable, meaningful components:

<scheme>://<authority>/good and or service name/telephone number/
condition/city/state/country

An example of the above URI might be:
http://athenslegalnews.com/wickerrockinqchair/555-555-2222/g/athens/tx/us
   The above example URI is immediately actionable by the user without selecting the hyperlink for further information. The user knows instantly that there is a new, wicker rocking chair for sale in Athens, Tex. The user can call the telephone number, 555-555-2222, to ascertain more information or arrange to purchase the good. The user may also elect to transcribe the URI into a handwritten form of ‘wicker rocking chair (555)555-2222’ for future reference.

The URI generated by the server scripts, in accordance with the DTD and/or schema, becomes a unique identifier in its own right, and it becomes the ID attribute for all references to this particular good and/or service, whether in a form, table, RSS/XML file, searchable content, or other means.

Applying the unique identifier in the form of a URI as derived from the GSLL to the ID attribute of a form indelibly identifies the data contained in said form to the physical location and description of a good and/or service until that good and/or service no longer exists in stated physical location. Hence, the contents of a form can be recalled by the URI.

The invention uses an SGML DTD and/or schema to define name-value pairs received from inputs in a form as sent across a communications means like HTTP. When a client sends a filled in form to the server, scripts residing in memory on the server parse the name-value pairs received from the form, similar to “state”=“Texas”, against the required elements contained in the DTD and/or schema. Using regular expressions, the data is sorted and written to four places, (1) a URI, (2) an approval page, (3) an RSS file, and (4) a database.

In this embodiment set forth, a form is presented to a client from a server in which form input mechanisms are mapped to elements declared and defined in the GSLL, where name=<!ELEMENT>and value=““is input by the user, either manually or automatically through a network interface like a web service, in character strings. The form is submitted to the server over an HTTP communications means in the form of name-value pairs like
“city=wimberely&state=texas&country=us”

Scripts running in memory on the server, with at least one processor, run programmatic operations on the data assembling the name-value pairs into a hash table which is then checked by a parser residing in memory on same server for elements declared in the GSLL. Scripts then further order the data into the sought after URI components and generate the appropriate URI character string. Scripts attach the URI as a unique identifier to the ID attribute of the form and/or table cell(s) as the form and/or table is programmatically rendered and displayed as an approval page to the user. Upon acceptance of the content contained in the approval page, which includes the URI, the user either clicks a button, selects a check box or radio box, or gives a voice sound command indicating the approval page is accepted and the scripts on the server should proceed to process the user request. The user is redirected to a payment page, which may be linked to a third party payment fulfillment vendor. Meanwhile, the server scripts process the user request into a URI under the appropriate namespace and display the URI in a directory hosted by the server, add the data to a searchable database, and display an RSS/XML feed, all displays tied together by one common URI unique to said good and/or service.

Each server, and there may be multiple servers, typically includes a central processing unit, at least one microprocessor coupled to memory, which may include random access memory as well as cache memories, flash memories, read-only memories and virtual memories. Each server operates under the control of an operating system (Unix, Linux, Windows, Apache) and executes and/or relies on software applications, programs, components, modules, objects, namespaces, and data structures. Each database relies on the namespace provided by the script package or module. A separate ping server may be employed to fully execute the ping functions and schedules set forth in support of the RSS/XML feed. Each server, one of which may be a proxy server, includes at least one or more network interfaces with one or more networks (LAN, WAN, wireless network, TCP/IP, Internet), and it should be noted that each server includes interfaces between analog and digital components or devices.

It is vital to appreciate that the present invention disclosed herein is capable of being implemented in a variety of software and hardware configurations, and that the present invention disclosed herein applies equally regardless of the type of signal bearing media used in implementation.

### BRIEF DESCRIPTION OF THE DRAWING

FIG. 1 is a block diagram illustrating the steps for structuring a URI using this invention.

### DETAILED DESCRIPTION OF THE PRESENT INVENTION

The present invention is a process and method to define, describe, order, and display the components that comprise the query portion of a Uniform Resource Identifier (URI) into a human readable, easy to remember string of characters that map the physical location of a resource.

In the following detailed description, numerous specific details are described in specific order to provide a more thorough description of the present invention. It will be clear to one skilled in the art that the present invention may be practiced without these specific details. Well-known features have not been described in detail so as not to cause confusion or obscure the present invention.

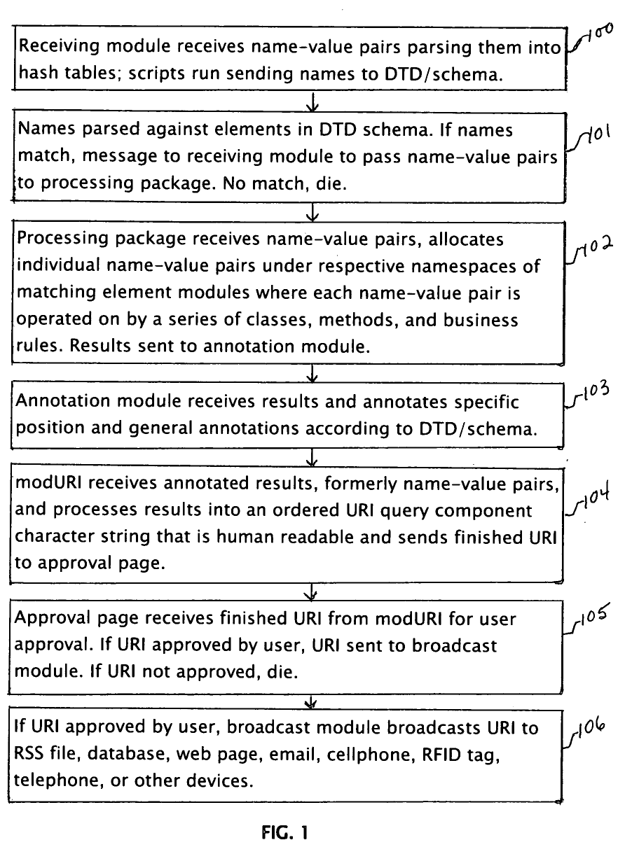

FIG. 1 is a block diagram illustrating the steps for structuring a URI using this invention. Name-value pairs are sent from a form or comma separated batch file 100 to memory where the receiving module scripts parse the name-value pairs into hash tables. The names are sorted and sent to the DTD/schema 101 for parsing. If the names match agreed upon elements in the DTD/schema, a message is sent back to the receiving module to proceed on. If the names do not match agreed upon elements in the DTD/schema, a notification to terminate is sent to the receiving module instead. If proceeding on, the receiving module sends individual name-value pairs to respective namespaces of matching element modules in the processing package 102, where each name-value pair is operated on by a series of classes, methods, and business rules. After being operated on independently, the resulting values are annotated and passed on to the annotation module 103 for specific position as well as general annotation according to the DTD/schema, the results of which can be saved for further reference in a flat file or database. The annotated results, formerly name-value pairs, are then passed to modURI 104 where scripts process the annotated results into an ordered URI query component character string that is human readable. modURI can process the URI into other formats, like a URL subset, as required. mod-URI sends the finished URI to the approval page 105 for user approval. If approved by the user, the URI is broadcast according to user request by the 106 broadcast module to options like an RSS file, database, web page, email, cellphone, RFID tag, or telephone.

In this manner, the present invention defines, describes, orders, and displays the components comprising the query portion of a Uniform Resource Identifier (URI) into a human readable, easy to remember string of characters that map the physical location of a resource.

What is claimed is:

1. A process and method for defining, describing, and displaying components comprising a Uniform Resource Identifier (URI) in a human-readable, actionable form for display as a URI or Uniform Resource Locator (URL) in a web browser address window or in similar display field(s) of an electronic device or via spoken sounds or handwritten text, the components derived from elements, attributes, and arguments defined in the Goods and Services Locator Language (GSLL), an SGML application, with computer executable instructions configured to determine data and direct a computing device to generate a unique identifier in the form of a URI in compliance with a GSLL Document Type Definition (DTD) and/or schema, where the computer readable media and instruction sets residing in memory consist of form data transmitted over a communications means, a parser and scripts capable of handling hash tables, name-value pairs, regular expressions, and SGML/XML applications, the elements consisting of; A Uniform Resource Name (URN) being
<! DOC TYPE gsll PUBLIC “+//ATHENSLEGALNEWS - Goods and
Services Locator Language
GSLL//DTD gsl
and the following elements, attributes, and arguments;
a language element that declares the text language of data presented in the application;
a code element listing a numerical or textual value for a good and/or service;
a condition element indicating the condition of a good and/or service with the value green being new and under full warranty, the value yellow being new or used under limited warranty, and the value red being “as is, where is”;
a name element or title of a good and/or service;
a telephone element containing the telephone number to call for direct information about a good and/or service;
a city element pointing to the physical location of a good and/or service, such being a city;
a state element pointing to the physical location of a good and/or service, such being a state;
a country element pointing to the physical location of a good and/or service, such being a country;
a description element describing a good and/or service;
a street address element pointing to the physical location of a good and/or service, such being a street address;
a gps coordinates element pointing to the physical location of a good and/or service, such being global positioning coordinates;
a zip code element pointing to the physical location of a good and/or service, such residing in a zip code;
a quantity element indicating the number of units of a good and/or service available for sale;
a means of sale element indicating how a good and/or service is offered for sale either through a negotiated sale, or a sealed bid, or an auction, or by barter;
a contact name element of the person responsible for selling a good and/or service;
an email element of the contact person and/or business selling a good and/or service;
a trial element indicating whether a trial version of a good and/or service is available;
a street address element of contact person or business if different from physical location of good and/or service;
a city element of contact person or business if different from physical location of good and/or service;
a state element of contact person or business if different from physical location of good and/or service;
a zip code element of contact person or business if different from physical location of good and/or service;
a country element of contact person or business if different from physical location of good and/or service;
a company name element;
a timestamp element;
a URL element of company website or differing specification information for a good and/or service if separate from landing page;
a ping list element indicating a private, seller provided RSS/XML feed ping list;
a media element indicating the type of media expected on a webpage, landing page, and/or contained in a file for a good and/or service;
a business description element of the business providing the good and/or service for sale;
an element indicating the days and hours a business is open;
a credit card element indicating whether a business accepts credit cards for the sale of a good and/or service;
an article element containing any content, but must have a title, author, and optional publication date and name of publishing company as attributes;
an alt tag element containing tool tips;
a help element containing context-sensitive help and/or links to help files;
a bundle element indicating URI attachment to a table cell.

2. A method of applying a unique identifier in the form of a Uniform Resource Identifier (URI) as generated according to the Goods and Services Locator Language (GSLL) to the ID attribute contained in a computer or electronic readable form and/or table causing the form and/or table to be uniquely identified by said URI henceforth and providing the means for “bundling” of cells in a table, such as an HTML, XHTML, or XML table, where the ID attribute equals the URI of a separate good and/or service in each cell, the display of all cells presenting the necessary goods and/or services to form at least one good and/or service for offer;
and where the URI, through element media of the GSLL, provides the user an indication of the plurality and type of media to be found in each cell, such as an image, a movie, an audio file, a Flash demo, a Powerpoint presentation, so the user can have the correct plug-in(s) available to interact with the media contained in the cell.

3. A process and method whereby a form is presented to a user with form inputs being defined by the Goods and Services Locator Language (GSLL);
data received from the user via the POST method across a communications medium such as HTTP is manipulated by scripts and a parser residing in memory on the computer server as name-value pairs;
a script is any programming language, whether interpreted or compiled, capable of handling hash table data structures;
said name-value pairs are optionally parsed against the elements declared in the GSLL, and a human-readable, immediately actionable Uniform Resource Identifier (URI) is composed for display, the URI being a unique identifier for a conceptual entity mapping of a resource to the physical location of that resource, being a good and/or service, in a given space and time period;
expiry date of a URI may be indicated by a timestamp;
a URI may be used as a key in a hash table;
the URI is displayed in the address bar of a web browser;
the URI is displayed in a landing page;
the URI is displayed as the unique identifier in the ID attribute of a form and/or table cell;
the URI is displayed as a searchable listing from a database;
the URI is displayed as a the title and link in an RSS/XML feed;
the URI can be classified further as a name, locator, or both for a good and/or service;
the URI and its subset the Uniform Resource Locator (URL), can be used with an electronic device such as, but not limited to, a computer, mobile phone, smart phone, personal digital assistant, interactive television system, voice response system, peer-to-peer network, kiosk, network appliance, RFID tag, as well as a writing device; and
the URI can be transcribed in non-electronic form such as with ink and paper.
